(19) United States
(12) Patent Application Publication
(10) Pub. No.: US 2014/0198277 A1
(43) Pub. Date: Jul. 17, 2014

(54) LIQUID CRYSTAL DISPLAY

(71) Applicant: HANNSTAR DISPLAY CORP., New Taipei City (TW)

(72) Inventors: Chia-Hua Yu, New Taipei City (TW); Sung-Chun Lin, Tainan City (TW); Chung-Lin Chang, Kaohsiung City (TW); Chien-Ting Chan, Tainan City (TW); Hsuan-Chen Liu, Kaohsiung City (TW); Chun-Chin Tseng, Kaohsiung City (TW)

(73) Assignee: HannStar Display Corp., New Taipei City (TW)

(21) Appl. No.: 13/865,149

(22) Filed: Apr. 17, 2013

(30) Foreign Application Priority Data
Jan. 17, 2013 (CN) 201310017535.5

(51) Int. Cl. G02F 1/1362; G02F 1/1368

(52) U.S. Cl. CPC G02F 1/136286; G02F 1/1368
USPC 349/43

(57) ABSTRACT

A liquid crystal display includes a bottom substrate, at least one thin film transistor, an overcoat layer, a bottom common electrode, at least one pixel electrode and a liquid crystal layer. The thin film transistor is disposed on the bottom substrate, including a gate electrode, a source electrode and a drain electrode. The overcoat layer is disposed above the thin film transistor. The bottom common electrode is disposed on the overcoat layer. The pixel electrode is disposed above the bottom common electrode and electrically connected to the drain electrode. The liquid crystal layer is disposed above the pixel electrode.

### BACKGROUND OF THE INVENTION

1. Field of the Invention

The present invention relates to a liquid crystal display (LCD) with HannStar Ultra-high Aperture (HUA), and more particularly, to a liquid crystal display having a plurality of common electrodes with separate power supplies.

2. Description of the Prior Art

Liquid crystal displays have advantages of portability, low power consumption, and low radiation. Therefore, they are widely used in various portable information products, such as notebooks, personal data assistants (PDA), and have replaced CRT monitor in desktop computers gradually.

The driving theory of the conventional liquid crystal display includes providing common voltages and pixel voltages to the common electrodes and the pixel electrodes on the bottom substrate respectively to form an electric field in the liquid crystal layer for displaying image. In the liquid crystal display, agate electrode may cause kickback voltage Vp to the pixel, and the kickback voltage Vp is influenced by the capacitors between various electric devices of the pixel. The more the kickback voltage Vp, the greater the value of the kickback voltage of the common electrode is. The great value of the kickback voltage influences the voltage level of the common electrode to cause ripple voltage and abnormal images or bad performance, such as cross talk and greenish. Therefore, to decrease the abnormal images or increase performance of liquid crystal display by preventing the influence from kickback voltage is still an important issue for the manufacturer.

### SUMMARY OF THE INVENTION

It is one of the objectives of the present invention to solve the problem of the abnormal images or bad performance caused by high kickback voltage in the conventional liquid crystal display. The present invention provides a liquid crystal display having a plurality of separate or independent common electrodes, wherein the abnormal images caused by kickback voltage can be improved by adjusting the common voltage of each separate and independent common electrode.

In order to solve the above-mentioned problem, the present invention provides a liquid crystal display including a bottom substrate, a plurality of thin film transistors, an overcoat layer, a bottom common electrode, a plurality of pixel electrodes and a liquid crystal layer. Each of the thin film transistor is disposed on the bottom substrate and includes a gate electrode, a source electrode, and a drain electrode. The overcoat layer is disposed above the thin film transistors. The bottom common electrode is disposed on the overcoat layer. The pixel electrode layers are disposed above the bottom common electrode, electrically connected to the drain electrodes respectively. The liquid crystal layer is disposed above pixel electrodes.

In order to solve the above-mentioned problem, the present invention further provides a liquid crystal display, including a bottom substrate, a plurality of thin film transistors, an overcoat layer, a plurality of bottom sub-common electrodes, a plurality of pixel electrodes, and a liquid crystal layer. Each of the thin film transistor is disposed on the bottom substrate and includes a gate electrode, a source electrode, and a drain electrode. The overcoat layer is disposed above the thin film transistors, the bottom sub-common electrodes are disposed on the overcoat layer. The bottom sub-common electrodes are not electrically connected to each other. The pixel electrodes are disposed above the bottom sub-common electrodes and electrically connected to the drain electrodes respectively. The liquid crystal layer is disposed above the pixel electrodes.

It is an advantage of the present invention that the liquid crystal display includes separate common electrodes to provide separate voltage supplies, such that the voltage level of each common electrode can be adjusted individually to improve the performance and avoid abnormal images caused by kickback voltages.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic sectional diagram of a single pixel of the liquid crystal display according to a first embodiment of the present invention.

FIG. 2 is a schematic diagram of the disposition of the common electrode of the liquid crystal display shown in FIG. 1.

FIG. 3 is a schematic top-view diagram of a portion of the liquid crystal display of a variant of the first embodiment of the present invention.

FIG. 4 is a schematic diagram of the disposition of the common electrodes of a liquid crystal display according to a second embodiment of the present invention.

FIG. 5 is a schematic partial top view of the liquid crystal display shown in FIG. 4.

FIG. 6 is a schematic diagram of the disposition of the common electrode of a liquid crystal display according to a third embodiment of the present invention.

FIG. 7 is a schematic partial top view of the liquid crystal display shown in FIG. 6.

FIG. 8 is a schematic sectional diagram of a liquid crystal display according to a fourth embodiment of the present invention.

FIG. 9 is a schematic diagram of the disposition of the common electrode of the liquid crystal display shown in FIG. 8.

### DETAILED DESCRIPTION

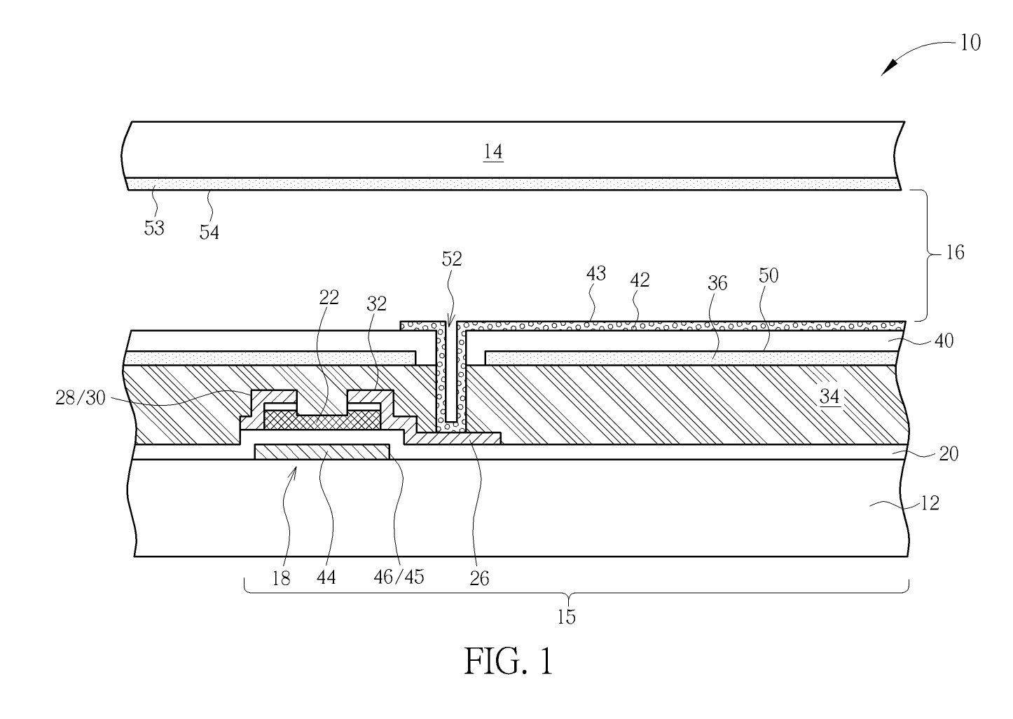

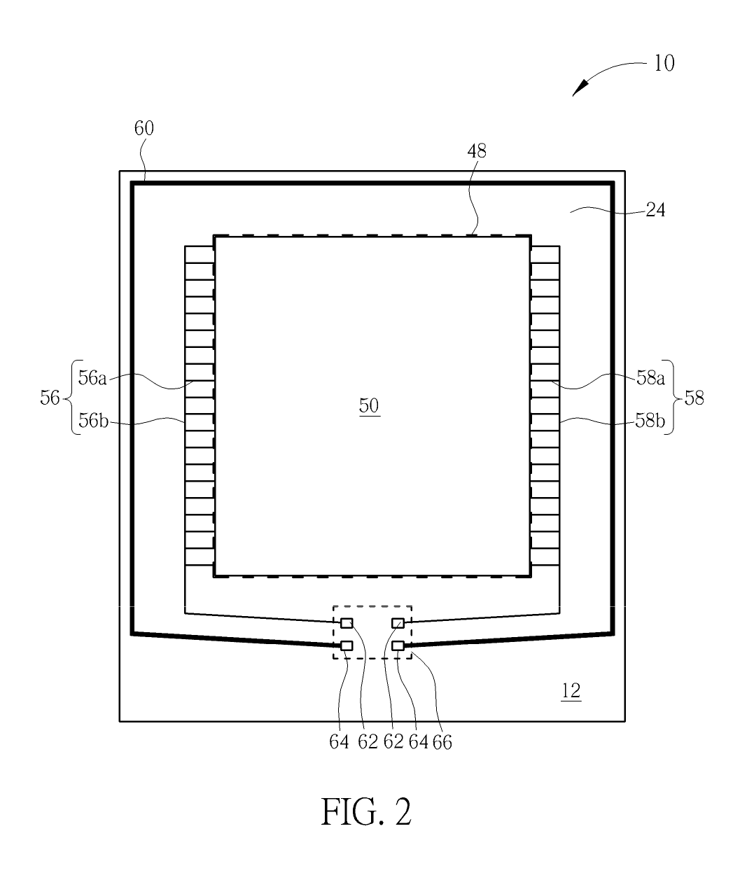

Referring to FIG. 1 and FIG. 2, FIG. 1 is a schematic sectional diagram of a single pixel of the liquid crystal display according to a first embodiment of the present invention, and FIG. 2 is a schematic diagram of the disposition of the common electrode of the liquid crystal display shown in FIG. 1. As shown in FIG. 1, the present invention liquid crystal display 10 includes a bottom substrate 12, a top substrate 14 and a liquid crystal layer 16 disposed between the top substrate 14 and the bottom substrate 12. The liquid crystal display 10 further includes at least one thin film transistor 18, an overcoat layer 34, a bottom common electrode layer 36, an insulating layer 40 and a pixel electrode layer 42. The thin film transistor 18 is disposed on the surface of the bottom substrate 12, including a gate electrode 46, a source electrode 30 and a drain electrode 32. The gate electrode 46 is formed with a first conductive layer 44, such as a first metal layer. The channel layer 22 is disposed above the gate electrode insulating layer 20 and is electrically connected to the source electrode 30 and the drain electrode 32. The source electrode 30 and the drain electrode 32 may be formed with a same layer, the second conductive layer 26, such as a second metal layer.

The HUA (HannStar Ultra-high Aperture) technology is adopted in the present invention liquid crystal display 10. The overcoat layer 34 is disposed above the thin film transistor 18 and the bottom substrate 12, and may be composed of colored transparent material or transparent high-polymer material. The bottom common electrode layer 36 is disposed on the overcoat layer 34 and includes at least one bottom common electrode 50. The bottom common electrode layer 36 is preferably composed of transparent conductive material, such as indium tin oxide (ITO), but not limited thereto. The insulating layer 40 is disposed on the bottom common electrode layer 36. The insulating layer 40 and the overcoat layer 34 have an opening 52 that exposes a portion of the drain electrode 32. The pixel electrode layer 42 is disposed above the bottom common electrode layer 36 and the insulating layer 40, and includes at least one pixel electrode 43, wherein the pixel electrode 43 is electrically connected to the drain electrode 32 through the opening 52. The pixel electrode layer 42 is preferably formed with transparent conductive material, such as ITO, but not limited thereto. The liquid crystal layer 16 is disposed above the pixel electrode layer 42. According to the structure of the present invention liquid crystal display, the opening ratio can be raised.

In this embodiment, the liquid crystal display 10 is a twisted nematic (TN) liquid crystal display. Accordingly, the top common electrode layer 53 is further disposed on the bottom surface of the top substrate 14, above the liquid crystal layer 16, and the top common electrode layer 53 includes a top common electrode 54. Preferably, the top common electrode layer 53 is formed with transparent conductive material, such as ITO.

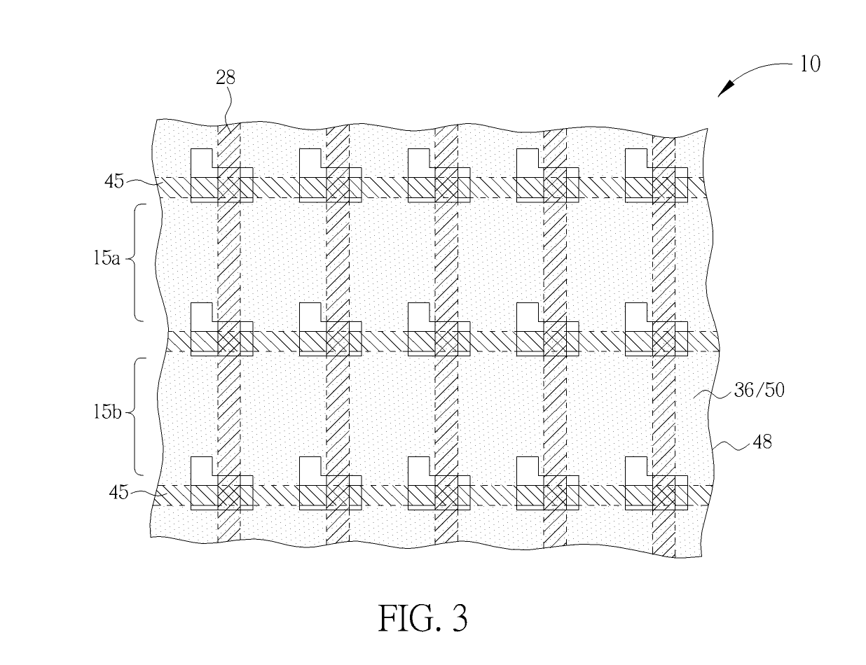

Referring to FIG. 3 with FIGS. 1-2, FIG. 3 is a schematic top-view diagram of a portion of the liquid crystal display of a variant of the first embodiment of the present invention. There are a display area 48 and a periphery area 24 (shown in FIG. 2) defined on the surface of the bottom substrate 12. The display area 48 is used for displaying images, and the periphery area 24 maybe used for arranging conductive lines. The display area 48 may further include at least one data line 28 and at least one scan line 45, respectively electrically connected to the source electrode 30 and the gate electrode 44. FIG. 3 shows a plurality of data lines 28 and a plurality of scan lines 45 for example. The data lines 28 and the scan lines 45 are substantially perpendicular to each other to define at least one pixel region 15 (shown in FIG. 1). As shown in FIG. 1, the overlapping portion of each data line 28 and one pixel region 15 or the thin film transistor 18 may serve as the source electrode 30, and the overlapping portion of each scan line 45 and one pixel region 15 or the thin film transistor 18 may serve as the gate electrode 46. The bottom common electrode layer 36 (the bottom common electrode 50) of this embodiment covers the scan lines 45, the data lines 28, and a majority portion of the pixel regions 15 (such as the pixel regions 15a and 15b in FIG. 3). Therefore, the common electrode 50 in the whole display area 48 has the same bottom common voltage level and may be electrically connected to a voltage supply out of the display area 48 through a plurality of conductive lines.

As shown in FIG. 2, the conductive line 56 and the conductive line 58 may be disposed in the periphery area 24 at two sides of the display area 48 on the surface of the bottom substrate 12 respectively, for electrically connecting the bottom common electrode 50 to the bonding pads 62. The conductive line 56 includes a least one sub conductive line 56a and a main conductive line 56b, and the conductive line 58 includes at least one sub conductive lines 58a and a main conductive line 58b. Although FIG. 2 illustrates a plurality of sub conductive lines 56a and a plurality of sub conductive lines 58a, the numbers of the sub conductive lines 56a and 58a may be varied optionally. In other embodiments, the conductive lines 56 and 58 may only have one single sub conductive line 56a and one single sub conductive lines 58a respectively. The sub conductive lines 56a, the main conductive line 56b, the sub conductive lines 58a, and the main conductive line 58b may be formed with the same conductive layer or with different conductive layers, and may be formed with one of the first conductive layer 44, the second conductive layer 26, the bottom common electrode layer 36, and the pixel electrode layer 42 or with other conductive layers individually. For example, the sub conductive lines 56a and 58a may be formed with a transparent conductive material the same as the common electrode layer 36 or the pixel electrode layer 42, and the main conductive lines 56b and 58b may be formed with the first conductive layer 44 or the second conductive layer 26, but not limited thereto. However, the conductive lines 56, 58 may be both formed with the first conductive layer 44 or with the second conductive layer 26.

In addition, the top common electrode 54 disposed on the top substrate 14 may be electrically connected to the top common electrode conductive line 60 disposed on the surface of the bottom substrate 12 through a conductive film and may be electrically connected to the bonding pads 64 through the top common electrode conductive line 60, wherein the top common electrode conductive line 60 may be formed with one of the aforementioned conductive layers. It is noteworthy that the top common electrode 54 and the bottom common electrode 50 are not electrically connected to each other at all, which means the top common electrode 54 and the bottom common electrode 50 are separate and independent from each other. The bonding pads 62 and 64 are disposed in the chip bonding area 66 and may be electrically connected to external separate voltage supplies through a chip and a flexible printed circuit (FPC) individually. In FIG. 2, the conductive lines 58, 56 and the top common electrode conductive line 60 are electrically connected to different bonding pads 62 and 64 respectively, which illustrates that separate or different voltage supplies respectively provide the bottom common voltage and the top common voltage to the bottom common electrode 50 and the top common electrode 54 through the conductive lines 58, 56 and the top common electrode conductive line 60 when the liquid crystal display 10 displays images, wherein the top common voltage and the bottom common voltage may have the same voltage levels or have different voltage levels. For instance, the top common voltage may have the level of a general common voltage for driving the liquid crystal molecules of a TN type liquid crystal display, while the bottom common voltage may have any voltage level for adjusting the coupling capacitor of the common electrodes and other electric devices. For example, by adjusting the bottom common voltage, the ripple voltage caused from the coupling capacitor of the pixel region 15 and the common electrode in a conventional liquid crystal liquid may be limited to or localized in the bottom common electrode 50 according to the present invention, so as to avoid the influence of the ripple voltage to the top common electrode 54 and to solve the problem of abnormal images.

The liquid crystal display of the present invention is not limited by the aforementioned embodiment, and may have other different preferred embodiments and variants. To simplify the description, the identical components in each of the following embodiments are marked with identical symbols. For making it easier to compare the difference between the embodiments, the following description will detail the dissimilarities among different embodiments and the identical features will not be redundantly described.

Referring to FIG. 3, in order to simply illustrate the HUA technology and arrangement of some electric devices related to the present invention, only the data lines 28, the scan lines 45, the bottom common electrodes 50 and related devices and conductive lines are shown for explanation. In this variant, the liquid crystal display 10 includes a plurality of scan lines 45 and a plurality of data lines 28, which are perpendicular to each other to form a plurality of pixel regions. Some different pixel regions are marked with 15a or 15b in FIG. 3 respectively. As shown in FIG. 3, the bottom common electrode 50 covers almost the whole portion of each of the pixel regions 15a and 15b, across each data line 28, and covers at least a portion of each scan line 45. As a result, the bottom common electrode 50 disposed above the whole pixel regions 15a, 15b, the scan lines 45, and the data lines 28 have the same voltage level. The arrangement of the bottom common electrode 50 of this variant is substantially the same as that shown in FIG. 2, thus no further details will be repeated.

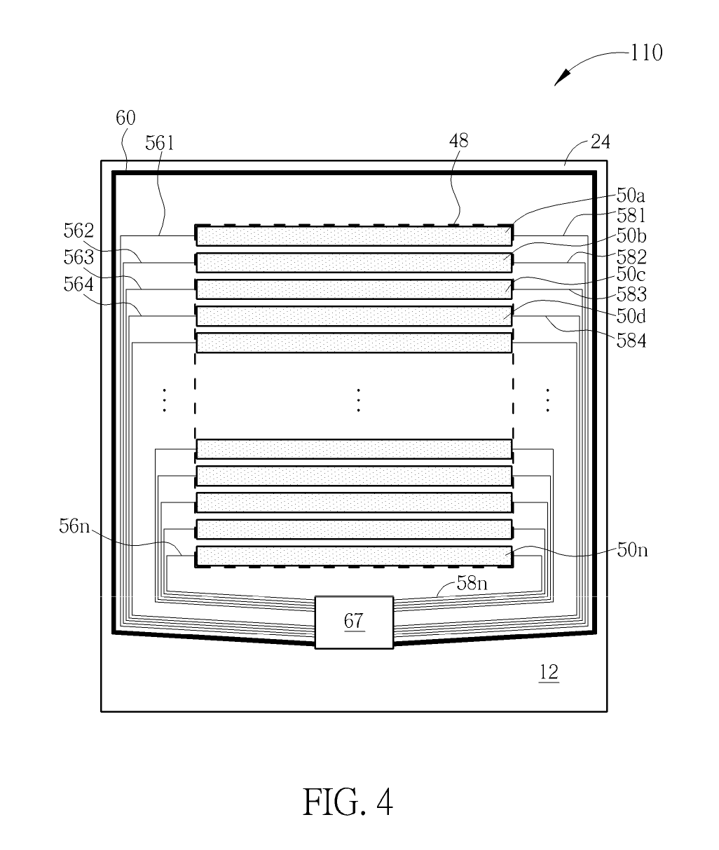

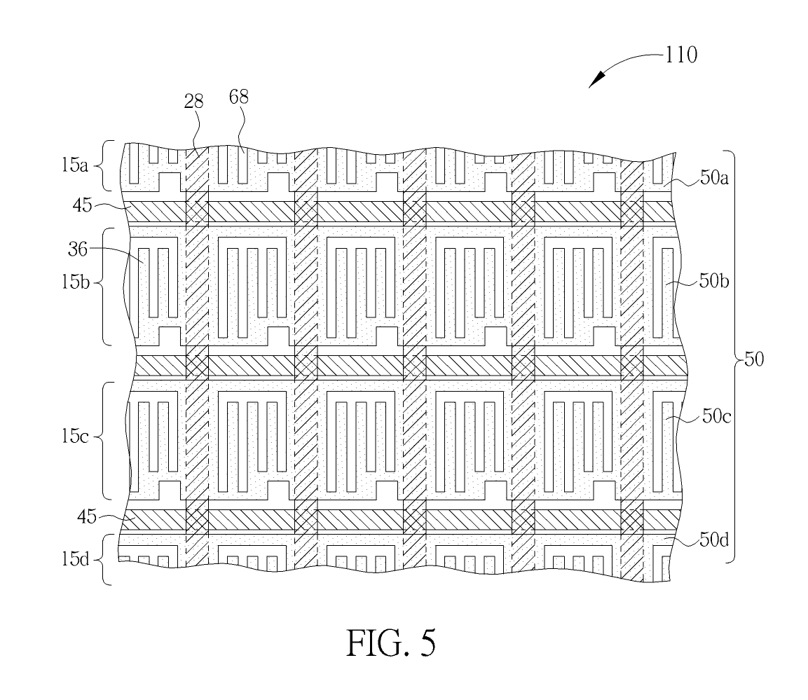

Referring to FIG. 4 and FIG. 5, FIG. 4 is a schematic diagram of the disposition of the common electrode of a liquid crystal display according to a second embodiment of the present invention, and FIG. 5 is a schematic partial top view of the liquid crystal display shown in FIG. 4. In order to simply illustrate the HUA technology of the present invention, only the data lines 28, the scan lines 45, the bottom common electrodes 50, and related devices and conductive lines are shown for explanation. In the liquid crystal display 110 of this embodiment, the bottom common electrode 50 includes a plurality of bottom sub-common electrodes 50a, 50b, 50c, 50d . . . 50n corresponding to a plurality of pixel regions respectively, which do not cover the scan lines 45 disposed between different bottom sub-common electrodes 50a, 50b, 50c, 50d . . . 50n. For example, the bottom sub-common electrode 50a is corresponding to and covers a plurality of pixel regions 15a arranged in a row along the horizontal direction of FIG. 5 and the data lines 28 disposed between the pixel regions 15a; the bottom sub-common electrode 50b is corresponding to and covers a plurality of pixel regions 15b arranged in a row and the data lines 28 disposed between the pixel regions 15b; the bottom sub-common electrode 50c is corresponding to and covers a plurality of pixel regions 15c and the data lines 28 disposed between the pixel regions 15c; and the bottom sub-common electrode 50d is corresponding to and covers a plurality of pixel regions 15d arranged in a row and the data lines 28 disposed between the pixel regions 15d. Each bottom sub-common electrode, such as 50b, does not covers the scan lines 45 disposed between any two adjacent bottom sub-common electrodes. In addition, the bottom sub-common electrodes 50a, 50b, 50c, 50d . . . 50n are electrically connected to different bonding pads of the chip 67 to correspond separate voltage supplies through the conductive lines 561, 562, 563, 564 . . . 56n at the left sides and the conductive lines 581, 582, 583, 584 . . . 58n at the right sides. Therefore, if the liquid crystal display 110 of this embodiment has n rows of pixel regions, the bottom common electrode 50 may include n bottom sub-common electrodes covering n rows of the pixel regions respectively and electrically connected to different bonding pads through n conductive lines at the left side and the right side of the display region 48 respectively.

As shown in FIG. 4, the bottom sub-common electrodes 50a, 50b, 50c, 50d . . . 50n are not electrically connected to each other. For simplifying the description, the following paragraphs uses the bottom sub-common electrodes 50a, 50b, 50c, 50d to represent all the bottom sub-common electrodes 50a, 50b, 50c, 50d . . . 50n. When the liquid crystal display 110 displays images, each of the bottom sub-common electrodes 50a, 50b, 50c, and 50d may have different or the same voltage levels individually, which may be different from or the same as that of the top common electrode 54. Since the voltage level of each of the bottom sub-common electrodes 50a, 50b, 50c, 50d can provide various and separate bottom common voltage from one separate voltage supply, the storage capacitor formed between the bottom sub-common electrodes 50a, 50b, 50c, 50d and the pixel electrodes 43 can be adjusted individually, such that the kickback voltages in different locations of the displayed image or display area 48 can be improved and thus to solve the problem of abnormal image. Furthermore, in different embodiments, the bottom sub-common electrodes 50a, 50b, 50c, 50d in the pixel regions 15a, 15b, 15c, and 15d may have various slits 68, such as comb-shaped slits, for further adjusting the storage capacitors of each location or each pixel region 15a, 15b, 15c, or 15d, but not limited thereto.

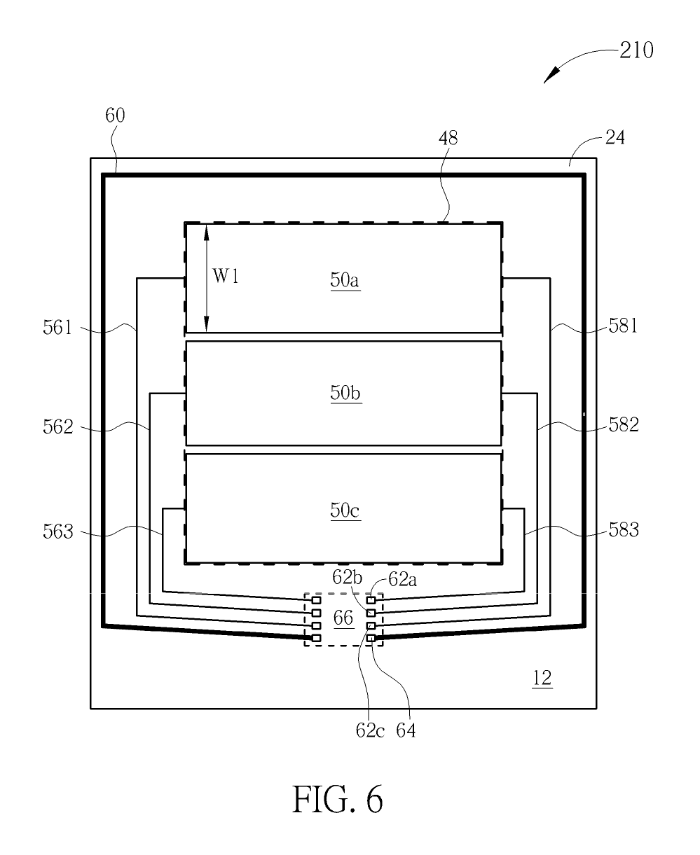

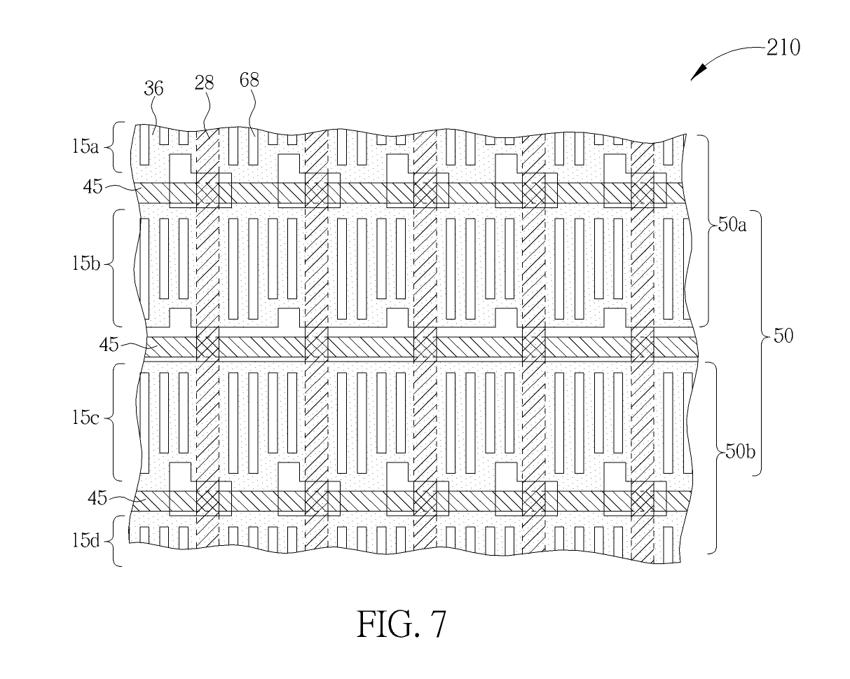

FIG. 6 is a schematic diagram of the disposition of the common electrodes of a liquid crystal display according to a third embodiment of the present invention, and FIG. 7 is a schematic partial top view of the liquid crystal display shown in FIG. 6. In order to simply illustrate the HUA technology of the present invention, only the data lines 28, the scan lines 45, the bottom common electrodes 50 and related devices and conductive lines are shown for explanation. In the liquid crystal display 210 of this embodiment, the bottom common electrode 50 includes three bottom sub-common electrodes 50a, 50b, 50c disposed in the display area 48, which are corresponding to and cover a plurality of pixel regions respectively. Noted that the number of the bottom sub-common electrodes 50a, 50b, and 50c is only an example for explanation, and the bottom common electrode 50 may include only two or include more than two bottom sub-common electrodes in various embodiments. In FIG. 7, the pixel regions in the first row along the horizontal direction are marked by 15a, the pixel regions in the second row are marked by 15b, the pixel regions in the third row are labeled by 15c, the pixel regions in the fourth row are marked by 15d, and the bottom sub-common electrodes 50a, 50b, 50c are corresponding to and covers several rows of the pixel region 15a, 15b, 15c, or 15d respectively. For example, FIG. 7 illustrates that the bottom sub-common electrode 50a is corresponding to at least the pixel regions 15a and 15b, and the bottom sub-common electrode 50b is corresponding to at least the pixel regions 15c and 15d. The bottom sub-common electrode 50a covers the data lines 28 of the pixel regions 15a, 15b and at least one portion of the scan line 45 disposed between the pixel regions 15a, 15b. Similarly, the bottom sub-common electrode 50b covers the data lines 28 of the pixel regions 15c, 15d and covers at least one portion of the scan lines 45 disposed between the pixel regions 15c, 15d. In addition, the bottom sub-common electrodes 50a, 50b, 50c, 50d of this embodiment may have slits 68, such as bar-shaped slits, for further adjusting the storage capacitor of each pixel region 15a, 15b, 15c, or 15d or each locations of the display area 48, but not limited thereto.

However, the scan lines 45 disposed between two adjacent bottom sub-common electrodes 50a, 50b, 50c are not covered by the bottom sub-common electrodes 50a, 50b, 50c. For example, in FIG. 7, the scan line 45 disposed between the pixel regions 15b and the pixel regions 15c are not covered by the bottom sub-common electrode 50a or 50b. In addition, the bottom sub-common electrodes 50a, 50b, 50c are not electrically connected to each other and are electrically connected to different bonding pads 62a, 62b, 62c through the conductive lines 561, 562, 563 at the left side and the conductive lines 581, 582, 583 at the right side respectively (shown in FIG. 6). As a result, the bonding pads 62a, 62b, 62c can provide different voltages to the bottom sub-common electrodes 50a, 50b, 50c respectively to improve the images affected by the kickback voltages indifferent locations. Furthermore, the surface of the periphery area 24 may include a top common electrode conductive line 60 for electrically connecting the bonding pads 64 to a top common electrode (as the top common electrode 44 in FIG. 1) disposed on the surface of the top substrate 14, so that the bottom sub-common electrodes 50a, 50b, 50c and the top common electrode 44 can provide different common voltages to the liquid crystal display 210 from a plurality of separate voltage supplies.

It is noteworthy that the bottom sub-common electrodes 50a, 50b, 50c may have various areas or may correspond to and cover different numbers of pixel regions or different numbers of rows of pixel regions according to different designs or requirements. For example, the areas of the bottom sub-common electrodes 50a, 50b, 50c can be adjusted by designing and adjusting the vertical width W of each of the bottom sub-common electrodes 50a, 50b, 50c, accompanied with providing different common voltages through the chip and external voltage supplies, so as to solve the problem of abnormal displayed images.

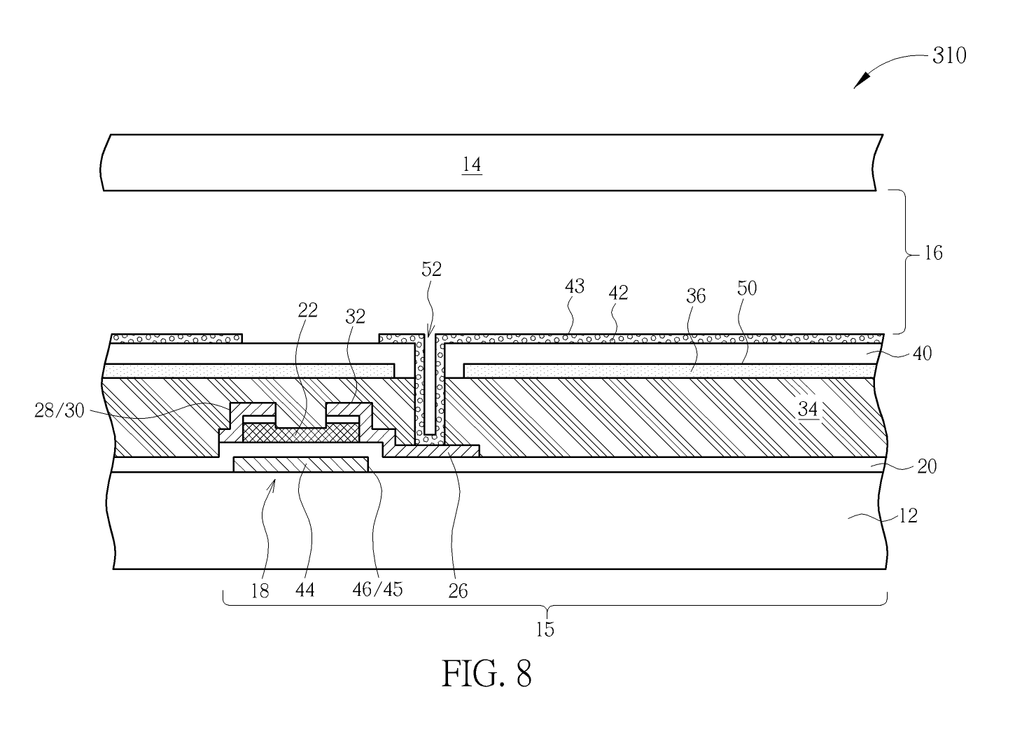

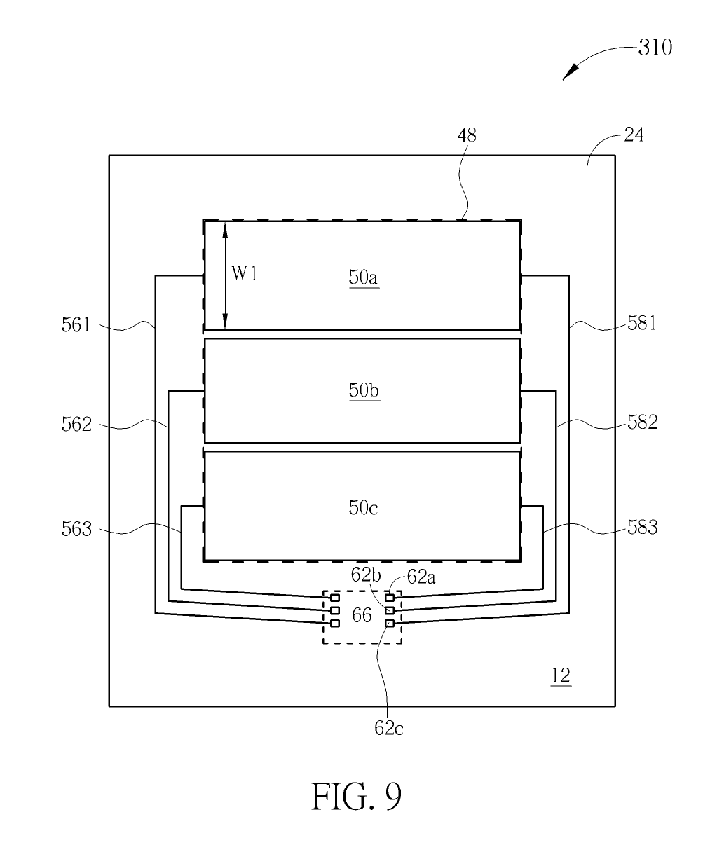

Please refer to FIG. 8 and FIG. 9. FIG. 8 is a schematic sectional diagram of a liquid crystal display according to a fourth embodiment of the present invention, and FIG. 9 is a schematic diagram of the disposition of the common electrodes of the liquid crystal display shown in FIG. 8. In order to simply illustrate the HUA technology of the present invention, only the data lines 28, the scan lines 45, the bottom common electrodes 50, and related devices and conductive lines are shown for explanation. Different from the third embodiment, the liquid crystal display 310 may do not include a top common electrode. For example, the liquid crystal display 310 is an in-plane switching (IPS) liquid crystal display. Therefore, only a plurality of bottom sub-common electrodes 50a, 50b, 50c are disposed on the surface of the bottom substrate 12. In addition, the top common electrode conductive line 60 and bonding pads 64 in the aforementioned embodiments of the surface of the bottom substrate 12 can be omitted since there is no top common electrode on the top substrate 14. Furthermore, in a variant of this embodiment, the amounts of the bottom sub-common electrodes and the conductive lines are not limited to the disclosure of FIG. 9, and may be various. For example, the liquid crystal display 310 may have n bottom sub-common electrodes and related conductive line as shown in FIG. 2.

In the above embodiments, the materials for forming the conductive lines 56, 58, 561, 562, 563, 581, 582, 583 and the top common electrode conductive line 60 disposed on the periphery area 24 are not limited, and for instance may be formed by one or two of the first conductive layer 44, the second conductive layer 26, the bottom common electrode layer 36, and the pixel electrode layer 42 respectively, but not limited thereto.

In conclusion, the present invention liquid crystal display includes at least two separate common electrodes which are independent to each other. By providing two separate common voltages to the two independent common electrodes from separate voltage supplies, the problem of high kickback voltage can be improved. If the two common electrodes are the top common electrode and the bottom common electrode respectively, the ripple voltage can be localized or limited to the bottom substrate by way of adjusting the bottom common voltage. In another aspect, if the liquid crystal display includes two or more bottom common electrode, which are represented as the separate bottom sub-common electrodes in the above embodiments, different and separate bottom common voltages can be provided to the bottom sub-common electrodes for adjusting the coupling capacitors and ripple voltages of different locations of the display area. Accordingly, the displayed image can be improved by providing two or more different separate common voltages to the liquid crystal display and the problem of abnormal image can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display, comprising:
a bottom substrate;
a plurality of thin film transistors disposed on the bottom substrate, each of the thin film transistors including a gate electrode, a source electrode, and a drain electrode;
an overcoat layer disposed above the thin film transistors;
a bottom common electrode disposed on the overcoat layer;
a plurality of pixel electrodes disposed above the bottom common electrode and electrically connected to the drain electrodes; and
a liquid crystal layer disposed above the pixel electrodes.

2. The liquid crystal display of claim 1, further comprising:
a plurality of scan lines disposed between the bottom substrate and the bottom common electrode and electrically connected to the gate electrodes; and
a plurality of data lines disposed between the bottom substrate and the bottom common electrode and electrically connected to the source electrodes.

3. The liquid crystal display of claim 2, wherein the bottom common electrode covers the data lines.

4. The liquid crystal display of claim 2, wherein the bottom common electrode does not cover the scan lines.

5. The liquid crystal display of claim 2, wherein the bottom common electrode includes a plurality of bottom sub-common electrodes.

6. The liquid crystal display of claim 5, wherein the bottom sub-common electrodes are not electrically connected to each other.

7. The liquid crystal display of claim 2, wherein the scan lines and the data lines define a plurality of pixel regions.

8. The liquid crystal display of claim 7, wherein each of the bottom sub-common electrodes is corresponding to a plurality of the pixel regions.

9. The liquid crystal display of claim 8, wherein each of the bottom sub-common electrodes covers the corresponding pixel regions.

10. The liquid crystal display of claim 8, wherein each of the bottom sub-common electrodes covers at least one portion of the scan lines disposed between the corresponding pixel regions.

11. The liquid crystal display of claim 8, wherein the bottom sub-common electrodes do not cover the scan lines disposed between two of the bottom sub-common electrodes adjacent to each other.

12. The liquid crystal display of claim 1, further comprising a top substrate and a top common electrode disposed on a surface of the top substrate.

13. The liquid crystal display of claim 12, wherein the top common electrode is not electrically connected to the bottom common electrode.

14. The liquid crystal display of claim 12, further comprising a plurality of conductive lines disposed on the bottom substrate for electrically connecting the bottom common electrode.

15. A liquid crystal display, comprising:
a bottom substrate;
a plurality of thin film transistors disposed on the bottom substrate, each of the thin film transistors including a gate electrode, a source electrode and a drain electrode;
an overcoat layer disposed above the thin film transistors;
a plurality of bottom sub-common electrodes disposed on the overcoat layer;
a plurality of pixel electrodes disposed above the bottom sub-common electrodes and electrically connected to the drain electrodes; and
a liquid crystal layer disposed above the pixel electrodes.

16. The liquid crystal display of claim 15, wherein the bottom sub-common electrodes are not electrically connected to each other.

17. The liquid crystal display of claim 15, wherein further comprises:
a plurality of scan lines disposed between the bottom substrate and the bottom sub-common electrodes and electrically connected to the gate electrodes respectively; and
a plurality of data lines disposed between the bottom substrate and the bottom sub-common electrodes and electrically connected to the source electrodes respectively;
wherein the scan lines and the data lines define a plurality of pixel regions, and the bottom sub-common electrodes cover the data lines.

18. The liquid crystal display of claim 17, wherein the bottom sub-common electrodes cover the pixel regions respectively and at least one portion of the scan lines disposed between the pixel regions.

19. The liquid crystal display of claim 17, wherein the bottom sub-common electrodes do not cover the scan line disposed between two of the bottom sub-common electrodes adjacent to each other.

20. The liquid crystal display of claim 15, further comprising a plurality of conductive lines disposed on the bottom substrate for electrically connecting the bottom sub-common electrodes respectively.
